(19) United States
(12) Patent Application Publication
(10) Pub. No.: US 2020/0400444 A1
(43) Pub. Date: Dec. 24, 2020

(54) SYSTEMS AND METHODS FOR ROUTING PERSONAL MOBILITY VEHICLES

(71) Applicant: Lyft, Inc., San Francisco, CA (US)

(72) Inventors: David Louis Bergman Quaid, New York, NY (US); Daniel Alan Gohike, Frederick, MD (US); Joshua Paul Roberts, Brooklyn, NY (US); Collin O'Neil Waldoch, Brooklyn, NY (US); Carter Robert Ren-Deh Wang, Brooklyn, NY (US)

(21) Appl. No.: 16/446,046

(22) Filed: Jun. 19, 2019

(51) Int. Cl. G01C 21/34; G06Q 10/02; G06Q 10/04; G06Q 10/06; G06Q 30/02; G06Q 50/30

(52) U.S. Cl. CPC G01C 21/343; G01C 21/3476; G06Q 10/02; G06Q 50/30; G06Q 10/06315; G06Q 30/0205; G06Q 10/043

(57) ABSTRACT

The disclosed computer-implemented method may include determining that one or more personal mobility vehicles would provide more benefit to the dynamic transportation network if the personal mobility vehicles were relocated and creating a dynamically generated tour for at least one user that ends with a personal mobility vehicle deposited by the requestor at a more beneficial location. In some embodiments, the dynamically generated tour may include one or more geographic points of interest that are expected to be relevant to the user. In some examples, the dynamically generated tour may be generated with various constraints such as time, distance, and battery usage. Various other methods, systems, and computer-readable media are also disclosed.

### BACKGROUND

Transportation services may provide transportation on demand, drawing from a transportation supply pool that includes vehicles of multiple types to meet the needs of those requesting transportation as such needs arise. Some transportation services may include personal mobility vehicles including, but not limited to, bicycles and scooters in a dynamic transportation network in order to enable users to complete portions of a journey more efficiently. In some examples, users may follow patterns of movement, such as using personal mobility vehicles to commute from the suburbs to the city center in the morning and reversing the pattern at the end of the day. In some cases, such patterns of movement may leave personal mobility vehicles out of position for some requestors. For example, a dynamic transportation matching system may have difficulty matching a user with a personal mobility vehicle in the city center after the evening commute.

Some traditional systems for relocating personal mobility vehicles to preferred locations may rely on third party contractors, incurring costs to the transportation service. Some traditional systems for relocating personal mobility vehicles may be suffer various other constraints and inefficiencies. Accordingly, the instant disclosure identifies and addresses a need for additional and improved systems and methods for routing personal mobility vehicles to preferred locations.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of a set of current locations and predicted request locations for personal mobility vehicles.

FIG. 2 is an illustration of an example tour containing multiple points of interest.

FIG. 3 is an illustration of an example tour containing points of interest of a specific type.

FIG. 4 is an illustration of two example tours with the same location.

FIG. 5 is an illustration of an example tour with different types of legs.

FIG. 6 is an illustration of an example route determined with criteria other than points of interest.

FIG. 7 is a block diagram of an example system for routing personal mobility vehicles.

FIG. 8 is a block diagram of an example system for a dynamic transportation matching system.

FIG. 9 is a flow diagram of an example method for routing personal mobility vehicles.

FIG. 10 is an illustration of an example requestor/provider management environment.

FIG. 11 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for routing personal mobility vehicles (PMVs) to locations that provide a benefit to a dynamic transportation network and/or dynamic transportation matching system. In some cases, PMVs may end up distributed in sub-optimal (from the transportation network perspective) locations. For example, commuters coming into the city center from the suburbs may lead to a regular pattern of a concentration of PMVs downtown during the day and a dearth of them at night. In some examples, disruptions to normal commute patterns such as weather may also leave PMVs out of position. For example, if the weather is clear in the morning but rainy in the evening, users may commute into the city center via PMVs in the morning but take cars home in the evening, leaving many PMVs out of position for the next morning's commute. In some embodiments, the systems and methods described herein may offer users PMV-based experiences that are designed to improve the placement of the PMVs. For example, the method may offer users riding tours that include one or more points of interest and that end at a target location with a better placement for the PMV than the starting location. In some examples, tours may be dynamically generated based on various factors and constraints, including areas with projected lack of supply, user interests and preferences, thematic consistency (e.g., a tour may be compiled to include related points of interest), timing (e.g., how soon the PMV will be needed at the endpoint and how long the tour is projected to take), etc. Additionally or alternatively, some offered experiences may include single-location experiences (e.g., offering a ride to a restaurant that is likely to interest a user and that is near a target location), workouts (e.g., offering a user interested in exercise an uphill ride on a bicycle toward a target location), and/or scenic rides. User interest may be determined based on explicitly provided preferences (e.g., the user has affirmatively indicated an interest in a tour) and/or inferred interests (e.g., the user is traveling and therefore is more likely to be interested in a tour).

Accordingly, as may be appreciated, the systems and methods described herein may improve the functioning of a computer that manages a dynamic transportation network. Furthermore, for the reasons mentioned above and to be discussed in greater detail below, the systems and methods described herein may provide advantages to the field of transportation management by providing an additional way to relocate PMVs to locations that are beneficial to a dynamic transportation network.

As will be explained in greater detail below, a dynamic transportation matching system may arrange transportation on an on-demand and/or ad-hoc basis by, e.g., matching one or more transportation requestors and/or transportation requestor devices with one or more transportation providers and/or transportation provider devices. For example, a dynamic transportation matching system may match a transportation requestor to a transportation provider that operates within a dynamic transportation network (e.g., that is managed by, coordinated by, and/or drawn from by the dynamic transportation matching system to provide transportation to transportation requestors).

In some examples, available sources of transportation within a dynamic transportation network may include vehicles that are owned by an owner and/or operator of the dynamic transportation matching system. Additionally or alternatively, sources of transportation within a dynamic transportation network may include vehicles that are owned outside of the dynamic transportation network but that participate within the dynamic transportation network by agreement. In some examples, the dynamic transportation network may include lane-bound vehicles (e.g., cars, light trucks, etc.) that are primarily intended for operation on roads. Furthermore, the dynamic transportation network may include PMVs that are not bound to traditional road lanes, such as scooters, bicycles, electric scooters, electric bicycles, and/or any other suitable type of personal mobility vehicle.

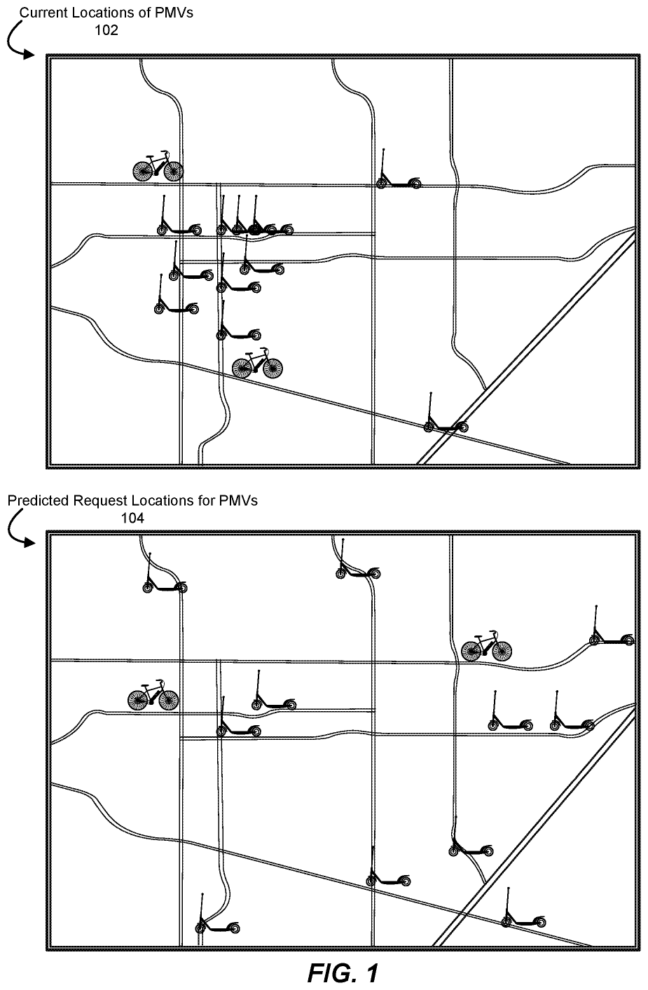

FIG. 1 illustrates a set of current locations and predicted request locations for PMVs. In some examples, the term “predicted request locations,” as used herein may refer to locations with a dynamic transportation matching system expects to receive future requests for transportation via PMVs. Additionally or alternatively, a predicted request location may include any location where it is beneficial to the dynamic transportation matching system to have a PMV located. For example, a predicted request location may be a location where potential users are likely to encounter PMVs and then decide to request the PMVs. As illustrated in FIG. 1, in some examples, a current location of PMVs 102 may include a cluster of PMVs located in one area, such as a city center. In some examples, PMVs may be concentrated across several blocks. In other examples, such as just before the start of a sporting event and/or concert, PMVs may be concentrated in a very small area, such as in front of a stadium. In some examples, the systems described herein may predict (e.g., based on a historical pattern of requests that occurred during similar time, date, and/or weather conditions) a set of predicted request locations for PMVs 104 in the near future (e.g., later within the same day) that does not match the current distribution of PMVs. In some examples, it may be costly, inefficient, and/or time-consuming to employ operators to move PMVs between locations when the PMVs are in working condition and could be used to transport users. While predicted request locations for PMVs 104 shows PMVs widely dispersed and current location of PMVs 102 shows PMVs clustered, in some examples, the opposite situation may occur and PMVs may be currently distributed across a large area but may be expected to be requested later in a comparatively narrow area. Similarly, PMVs may be clustered in one area but expected to be requested in a different area. In any cases, if there exists a disparity between the current locations of PMVs and the expected locations of near future requests for PMVs, it may be advantageous for a dynamic transportation matching system to facilitate the relocation of PMVs from their current locations to more preferable locations that more closely match the locations of expected future requests and/or usage.

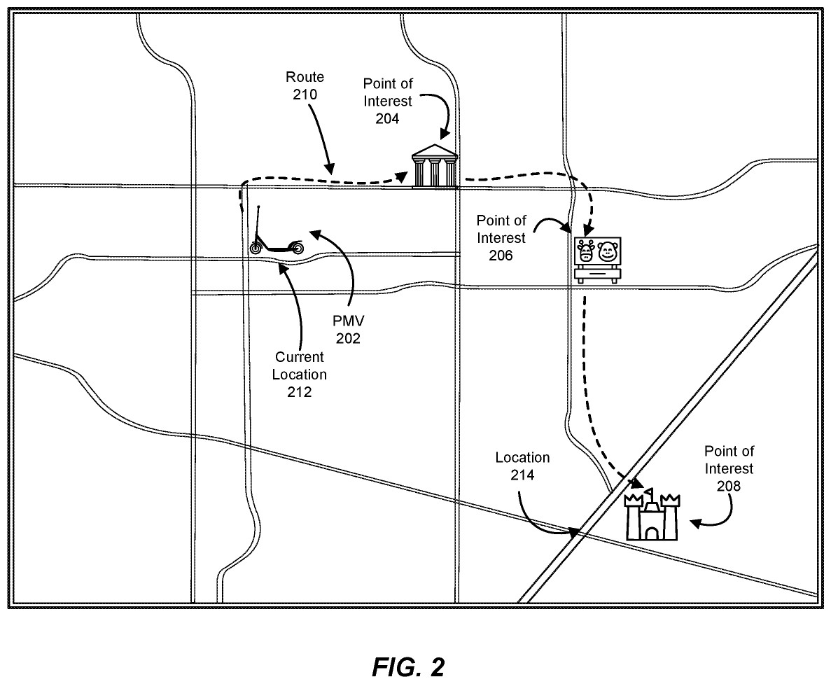

FIG. 2 illustrates an example tour containing multiple points of interest. As illustrated in FIG. 2, in some examples, a dynamic transportation matching system may determine that it is valuable to the dynamic transportation matching system to relocate a PMV 202 from a current location 212 to a location 214. In some embodiments, the systems described herein may determine the utility of relocating PMV 202 from current location 212 to location 214 by determining an expected utility of fulfilling a predicted future request at or near location 214 versus an expected utility of fulfilling a predicted future request at location 212.

In some examples, the term “utility,” as used herein, may refer to a metric and/or a numerical value calculated based on any of a variety of factors, including, but not limited to, the output of an objective function (e.g., where the utility of relocating the PMV is a marginal difference to the output of an objective function when the PMV is relocated), travel and/or walking distances (e.g., where the utility of relocating the PMV is based on a proximity of the PMV at the new location to a transportation requestor), an ability to meet transportation requests (e.g., where the utility of relocating the PMV is based on a level of requests for PMVs at the new location of the PMV), a cost to provision the new location with a PMV by a different method, user satisfaction, wear on PMVs, monetary cost and/or gain, and/or fuel and/or battery consumption. In one example, the systems described herein may predict a high future request volume at or near location 212 based at least in part on historical request patterns for location 212 and/or areas near location 212. In some examples, the predicted future request at or near location 212 may be may be farther in the future (e.g., the next day rather than later that same day) and/or otherwise lower utility to the dynamic transportation matching system, resulting in the dynamic transportation matching system determining that relocating PMV 202 to location 214 produces utility for the dynamic transportation matching system. Additionally or alternatively, the systems described herein may determine the utility of relocating PMV 202 from location 212 to location 214 via producing and/or comparing heatmaps of current locations and/or requests and expected future locations and/or requests, using a machine learning algorithm, and/or using any other suitable computational technique. In some embodiments, the systems described herein may calculate a utility of relocating a PMV based at least in part on an expected utilization rate of the PMV at the current location and/or at the target location. For example, the systems described herein may determine that PMVs at the current location have a 10% utilization rate (i.e., any PMV at the location has a 10% chance to be matched to a transportation requestor during a given span of time) compared to a 30% utilization rate at the target location.

In some examples, location 212 may be the location of a charging station, docking station, operations pick-up location, and/or other location specifically relevant to the dynamic transportation matching system. In some examples, it may be beneficial to the dynamic transportation matching system to relocate a PMV with a low battery charge level to a charging station. In one example, relocating a PMV to a charging station may enable the PMV to regain charge and later be available for requests that are more optimally fulfilled by a PMV with more charge than the current battery charge level of the PMV. Additionally or alternatively, relocating a PMV to a docking station may be beneficial for the dynamic transportation matching system by moving the PMV from a location where the PMV is difficult to find and/or likely to be damaged to a location that is safe and easily identified by transportation requestors. In some examples, relocating a PMV to a docking station and/or other highly visible location may prompt a transportation requestor to request a trip via the dynamic transportation matching system that the transportation requestor may not have requested if the transportation requestor had not encountered the PMV. In one example, relocating a PMV to an operations pick-up location may provide utility to the dynamic transportation matching system by increasing the efficiency of an operator that picks-up PMVs for inspection, maintenance, and/or other reasons by consolidating PMVs in one location and/or along a route, reducing the amount of time that the PMV is out of service. In some examples, relocating a PMV may produce utility for the dynamic transportation matching system by reducing the expected estimated arrival time (ETA) for a subsequent trip by moving the PMV to a target location that is more convenient for the transportation requestor of the subsequent trip. Additionally or alternatively, relocating a PMV may enable a transportation requestor to use the PMV to meet an additional transportation provider (such as a car) associated with the dynamic transportation network at a more convenient location than otherwise, reducing trip ETA for the transportation requestor and/or additional transportation requestors (e.g., during a shared ride) and/or improving transportation requestor experience. In some examples, relocating a PMV may increase the number of trips provided by the dynamic transportation matching system by enabling the PMV to be used in a trip that would not otherwise occur and/or would not otherwise utilize a PMV. In one example, relocating a PMV may reduce the strain on other resources in a dynamic transportation network (e.g., transportation providers, operators, etc.) by enabling a transportation requestor to complete a trip via the PMV rather than via another means of transportation associated with the dynamic transportation network.

In some embodiments, the systems described herein may have a dynamic threshold for utility. For example, the dynamic threshold for moving a PMV to a given location may be based at least in part on the utility of the PMV remaining in the current location. In one example, the systems described herein may make the determination to relocate a PMV from a current location to a target location if the utility of having the PMV at the target location exceeds the utility of having the PMV at the current location by a certain amount (which may be static or dynamic based on, e.g., the logistical difficulty of relocating the PMV).

In some embodiments, upon determining that relocating PMV 202 from location 212 to location 214 is valuable to the dynamic transportation matching system, the systems described herein may dynamically generate a tour that begins at or near location 212 and ends at or near location 214. In some embodiments, the systems described herein may first generate a tour and then identify a user who may be interested in the tour. In some examples, the user may be a transportation requestor who has requested transportation via the dynamic transportation network in the past. In other examples, the user may be a new user who has not previously requested transportation via the dynamic transportation network. Additionally or alternatively, the systems described herein may first identify a user who may be interested in a tour and then may generate a tour tailored to the constraints and/or preferences of that user. In one example, the systems described herein may generate a tour that traverses route 210 from point of interest 204 to point of interest 206 to point of interest 208, where point of interest 208 is located near location 214. The term “point of interest,” as used herein, generally refers to any geographic location that has one or more interesting features (e.g., features manually identified as interesting to users, identified by a machine learning process as interesting, retrieved from a database of features, etc.). For example, a point of interest may include a tourist attraction such as a zoo or museum, a historic location, a scenic lookout point, a restaurant and/or other dining venue, and/or any other suitable type of feature that may be interesting to visit. The systems described herein may select points of interest in a variety of ways. In some embodiments, the systems described herein may select points of interest along a route with a maximum travel distance. In one embodiment, the systems described herein may determine the shortest path between location 212 and location 214 and may select points of interest that are along and/or near that path. In some embodiments, the systems described herein may select points of interest by traversing a graph (e.g., where points of interest and/or other locations are vertices and distances are weights applied to edges).

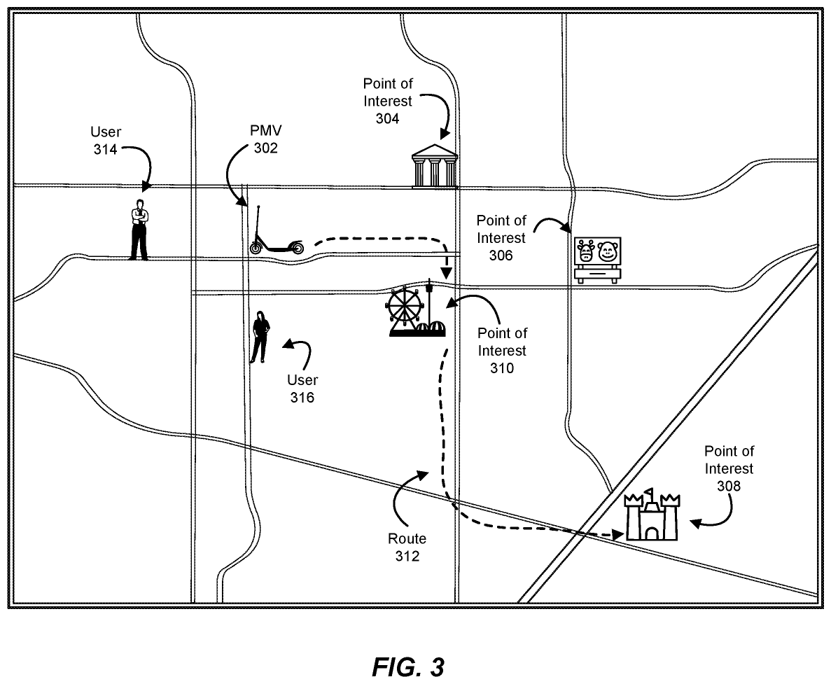

FIG. 3 illustrates an example tour containing points of interest of a specific type. In some examples, the systems described herein may tailor a route and/or tour to an individual user. For example, the systems described herein may determine that, based on preferences selected by user 316, user 316 is interested in amusement parks and similar attractions. Based on these preferences, the systems described herein may offer user 316 a tour via PMV 302 along route 312 that includes point of interest 310 and/or point of interest 308 but excludes point of interest 304 and/or point of interest 306. In some embodiments, the systems described herein may select points of interest based on inferred preferences that are inferred based on the past behavior of a user and/or other users with similar demographics (e.g., age, location, usage history, etc.). In some embodiments, the systems described herein may offer a user an option to traverse a route based on determining that the probability that the user will select the option is above a probability threshold. In one example, the systems described herein may offer a user an option to traverse a route that contains points of interests based at least in part on determining that the user is outside the area where the user typically operates and is therefore likely traveling (e.g., as a tourist on vacation). In some examples, the systems described herein may send a user an option to traverse a tour in response to receiving a request from a user to traverse a tour (e.g., by opting in to receive future options when available and/or sending a specific request to receive a tour option at the current time). Additionally or alternatively, the systems described herein may generate a tour that includes specific points of interest and then make the tour available to be selected by requestors. For example, the systems described herein may offer user 314 and user 316 an option to traverse route 312. In one embodiment, the systems described herein may display a library of available tours on an app. For example, the systems described herein may display options to use PMV 202 to traverse a route that ends at point of interest 208 via point of interest 304, point of interest 306, and/or point of interest 310.

In some examples, the systems described herein may generate a tour based on time constraints of a user and/or an expected future request. For example, user 316 may specify a time limit of two hours and/or the systems described herein may determine that it is valuable for PMV 302 to be located near point of interest 308 at a time two hours in the future. In one example, the systems described herein may determine that points of interest 310, 308, and 306 are all relevant to user 316 but that traversing a route including all three points of interest has a high probability of taking longer than two hours and may therefore offer a route that includes points of interest 310 and 308 but not point of interest 306. In some embodiments, the systems described herein may estimate the amount of time a user is expected to spend at a given point of interest based on the type of point of interest, previous behavior of the user, and/or previous behavior of other users at the point of interest. For example, the systems described herein may estimate that user 316 may spend ten minutes at a scenic lookout point and/or an hour at a zoo. In some examples, the systems described herein may generate tours with time flexibility to account for unpredictable user behavior. For example, the systems described herein may generate a tour that takes two hours to traverse and ends at a location where the PMV is expected to be request five hours in the future. Additionally or alternatively, the systems described herein may provide users with incentives to traverse routes within a specified time period. For example, the systems described herein may provide directions to additional points of interest if a user is traversing the route at an expected or faster than expected rate and/or may cease providing directions to additional points of interest (other than the final location) if the user is traversing the route slower than predicted. In some embodiments, the systems described herein may generate a route based at least in part on battery constraints of the PMV. For example, the systems described herein may generate a route with a high probability that the PMV will have at least 25% battery life remaining at the end of the route and/or may avoid generating a route that is predicted to drain the battery of the PMV below a certain percentage.

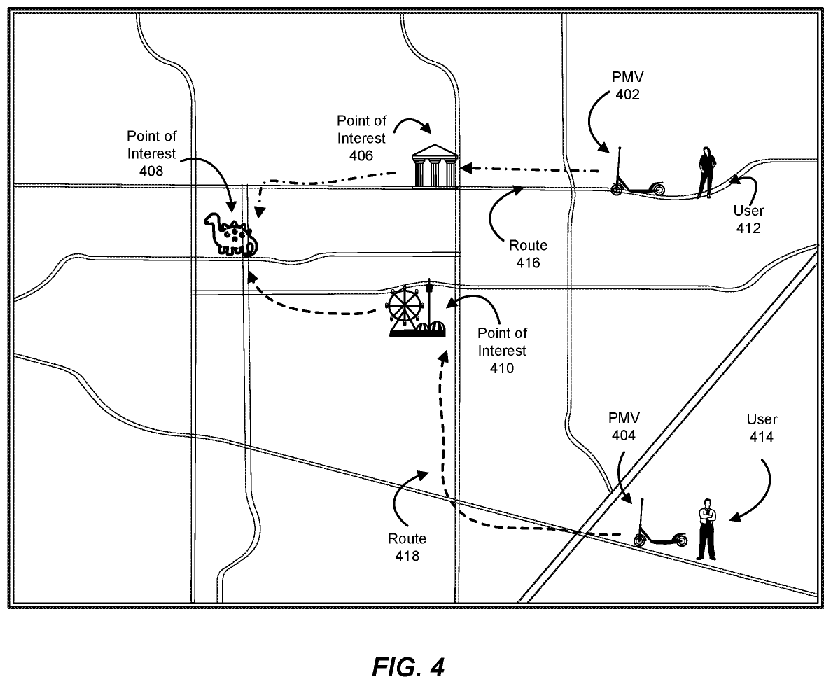

FIG. 4 illustrates two example tours with the same location. In some examples, it may be advantageous to the dynamic transportation matching system to consolidate multiple PMVs in one location. In some cases, it may be because multiple PMVs are expected to be requested at that location. Additionally or alternatively, it may be advantageous to consolidate multiple PMVs so that the PMVs can be easily picked up for charging, inspection, and/or other maintenance. In some examples, a particular location may feature a charging station and/or other PMV-related amenity and it may be advantageous to the dynamic transportation matching system to locate one or more PMVs at that location to interact with the amenity. For example, the dynamic transportation management system may determine that one or more PMVs is low on battery (e.g., below a threshold battery charge such as 30%, 25%, or 15%) and it is valuable to the dynamic transportation matching system to relocate the PMV to a charging station. In one example, the systems described herein may determine that it is valuable for PMV 402 and/or PMV 404 to be located at a location near point of interest 408. In some examples, the systems described herein may offer options to multiple users to traverse routes that end at point of interest 408. For example, the systems described herein may offer a user 412 an option to traverse, via PMV 402, a route 416 that includes point of interest 406 and point of interest 408. Similarly, the systems described herein may offer a user 414 the option to traverse, via PMV 404, a route 418 that includes point of interest 410 and point of interest 408.

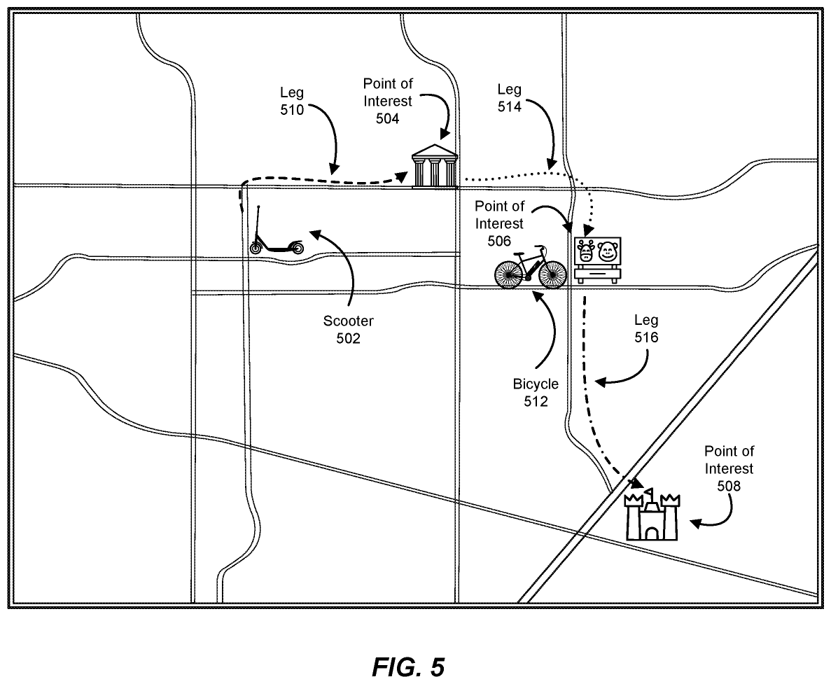

FIG. 5 illustrates an example tour with different types of legs. In some examples, the systems described herein may facilitate the relocation of multiple PMVs by offering a user a tour that includes operating one or more types of PMV and/or walking. For example, the systems described herein may offer a user an option to traverse a route that includes a leg 510 that is traversed via a scooter 502 and ends at point of interest 504, a leg 514 from point of interest 504 to point of interest 506 that is traversed by walking and/or a leg 516 from point of interest 506 to point of interest 508 that is traversed via bicycle 512. In some embodiments, the systems described herein may offer a tour to a user based in part on the type of PMV used to traverse one or more legs of the tour. For example, if a user has not yet operated an electric bicycle but is expected to be interested in doing so (e.g., due to preferences, past behavior, and/or behavior of similar users), the systems described herein may offer the user a tour that includes one or more legs traversed via an electric bicycle.

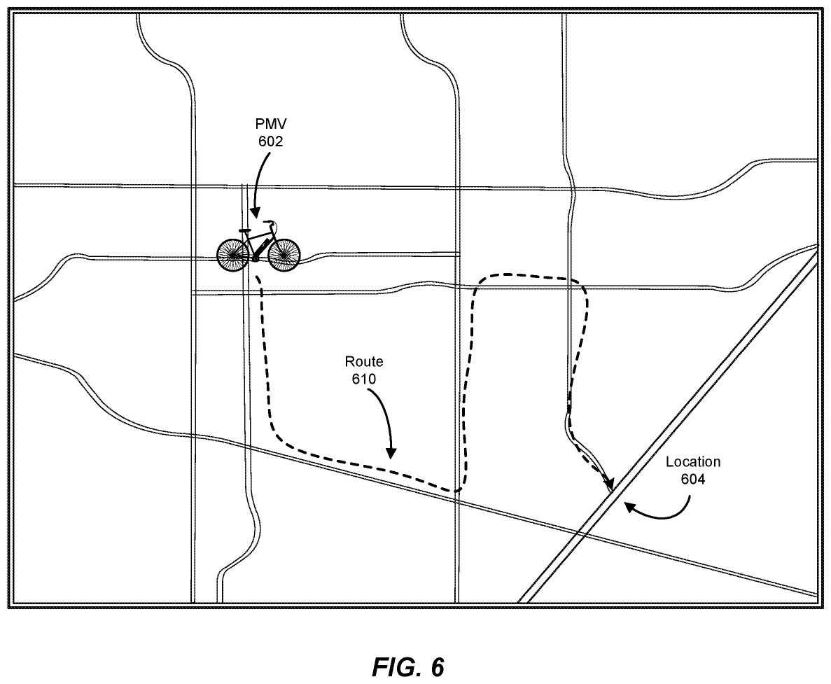

FIG. 6 illustrates an example route determined with criteria other than points of interest. In some embodiments, the systems described herein may offer routes and/or tours generated using criteria other than points of interest. For example, if a user has indicated a preference for exercise, the systems described herein may offer a user an option to traverse a route 610 via PMV 602 that is not the shortest traversable path to location 604. In some examples, the systems described herein may generate routes that are above a certain length, feature challenging terrain features (e.g., uphill and/or off-road), and/or are traversed by a certain type of PMV (e.g., a bicycle). In some embodiments, the systems described herein may generate routes with other characteristics, such as routes that form a picture on a map, routes that include a challenge to traverse the route within a certain time frame, and/or other suitable challenges. By generating routes that include challenges in place of and/or addition to points of interest, the systems described herein may facilitate the relocation of PMVs to and/or from areas that include few points of interest and/or by users who are not otherwise interested in visiting points of interest.

In some embodiments, the systems described herein may generate routes that include and/or terminate at single point of interest that is currently holding an event and/or is otherwise of interest to locals who may already have visited the point of interest in the past. For example, the systems described herein may generate a route that terminates at or near a restaurant that is currently offering discounts.

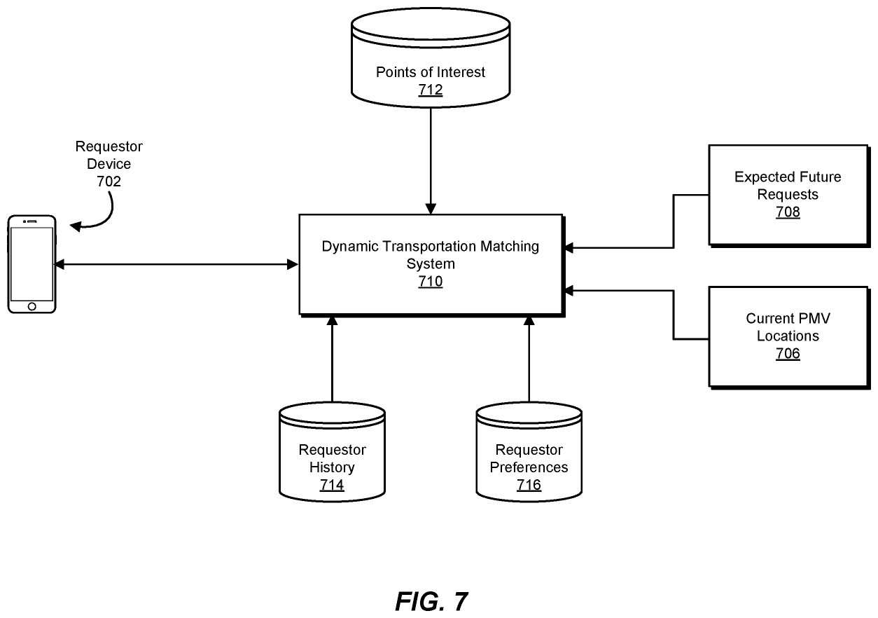

FIG. 7 is a block diagram of an example system for routing PMVs. In some embodiments, a dynamic transportation matching system 710 may examine current PMV locations 706 and/or expected future requests 708 in order to determine the utility of relocating one or more PMVs. In some embodiments, factors that are considered to calculate expected future requests 708 may include, without limitation, current metrics on PMVs within a geographic area, current weather, predicted weather, time of day, day of week, season of year, ratio of commuters to casual users in a given area, conditions in adjacent areas, region-level constraints, region-level PMV availability metrics, and/or historical PMV usage in the area. In some examples, dynamic transportation matching system 710 may determine that there is a shortage of PMVs in one area and/or a surplus of PMVs in another area. In some embodiments, dynamic transportation matching system 710 may generate tours using a database of points of interest 712. Points of interest 712 may be drawn from a variety of sources, including but not limited to map information about the region, reviews for businesses and/or locations within the region, and/or directories of points of interest. In some embodiments, points of interest 712 may be categorized by type, accessibility, hours open, category of user interest (e.g., art, historical, related to a given time period and/or culture, etc.), cost to enter and/or participate, average, maximum, and/or minimum amount of time spent by visitors, popularity, and/or quality of user reviews. In some examples, dynamic transportation matching system 710 may generate a tour for a user associated with a requestor device 702 by selecting points of interest from points of interest 712 based in part on requestor history 714 and/or requestor preferences 716. In some embodiments, dynamic transportation matching system 710 may send a message to requestor device 702 that includes an option to traverse the tour.

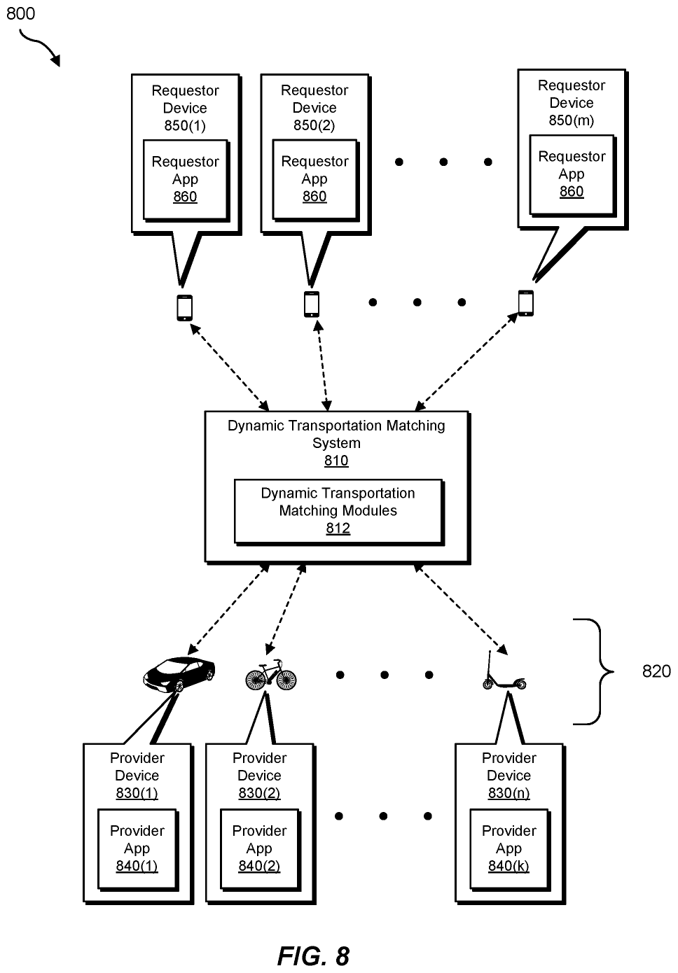

FIG. 8 illustrates an example system 800 for matching transportation requests with a dynamic transportation network that includes personal mobility vehicles. As shown in FIG. 8, a dynamic transportation matching system 810 may be configured with one or more dynamic transportation matching modules 812 that may perform one or more of the steps described herein. Dynamic transportation matching system 810 may represent any computing system and/or set of computing systems capable of matching transportation requests. Dynamic transportation matching system 810 may be in communication with computing devices in each of a group of vehicles 820. Vehicles 820 may represent any vehicles that may fulfill transportation requests. In some examples, vehicles 820 may include disparate vehicle types and/or models. For example, vehicles 820 may include lane-constrained vehicles (e.g., vehicles designed to operate within a standard road lane) and personal mobility vehicles. In some examples, some of vehicles 820 may be standard commercially available vehicles. According to some examples, some of vehicles 820 may be owned by separate individuals (e.g., transportation providers). Furthermore, while, in some examples, many or all of vehicles 820 may be human-operated, in some examples many of vehicles 820 may also be autonomous (or partly autonomous). Accordingly, throughout the instant disclosure, references to a “transportation provider” (or “provider”) may, where appropriate, refer to an operator of a human driven vehicle, an autonomous vehicle control system, an autonomous vehicle, an owner of an autonomous vehicle, an operator of an autonomous vehicle, an attendant of an autonomous vehicle, a vehicle piloted by a requestor, and/or an autonomous system for piloting a vehicle. While FIG. 8 does not specify the number of vehicles 820, it may be readily appreciated that the systems described herein are applicable to hundreds of vehicles, thousands of vehicles, or more. In one example, dynamic transportation matching system 810 may coordinate transportation matchings within a single region for 50,000 vehicles or more on a given day. In some examples, vehicles 820 may collectively form a dynamic transportation network that may provide transportation supply on an on-demand basis to transportation requestors and/or other users.

As mentioned above, dynamic transportation matching system 810 may communicate with computing devices in each of vehicles 820. The computing devices may be any suitable type of computing device. In some examples, one or more of the computing devices may be integrated into the respective vehicles 820. In some examples, one or more of the computing devices may be mobile devices. For example, one or more of the computing devices may be smartphones. Additionally or alternatively, one or more of the computing devices may be tablet computers, personal digital assistants, or any other type or form of mobile computing device. According to some examples, one or more of the computing devices may include wearable computing devices (e.g., a driver-wearable computing device), such as smart glasses, smart watches, etc. In some examples, one or more of the computing devices may be devices suitable for temporarily mounting in a vehicle (e.g., for use by a requestor and/or provider for a transportation matching application, a navigation application, and/or any other application suited for the use of requestors and/or providers). Additionally or alternatively, one or more of the computing devices may be devices suitable for installing in a vehicle and/or may be a vehicle's computer that has a transportation management system application installed on the computer in order to provide transportation services to users and/or communicate with dynamic transportation matching system 810.

As shown in FIG. 8, vehicles 820 may include provider devices 830(1)-(n) (e.g., whether integrated into the vehicle, permanently affixed to the vehicle, temporarily affixed to the vehicle, worn by a driver of the vehicle, etc.). In some examples, provider devices 830 may include a provider apps 840(1)-(k). Provider apps 840(1)-(k) may represent any application, program, and/or module that may provide one or more services related to operating a vehicle and/or providing transportation matching services. For example, provider apps 840(1)-(k) may include a transportation matching application for providers and/or one or more applications for matching personal mobility vehicles (PMVs) with requestor devices. In some embodiments, different types of provider vehicles may be provisioned with different types of provider devices and/or different provider applications. For example, PMVs may be provisioned with provider devices that are configured with a provider application that enables users to reserve and/or operate the PMV while road-constrained vehicles (e.g., cars) may be provisioned with provider devices that are configured with a provider application that enables provider vehicle operators (e.g., transportation providers) to respond to requests from users. In some examples, provider applications 840(1)-(k) may match the user of provider apps 840(1)-(k) (e.g., a transportation provider) with users through communication with dynamic transportation matching system 810. In addition, and as is described in greater detail below, provider apps 840(1)-(k) may provide dynamic transportation management system 810 with information about a provider (including, e.g., the current location of the provider and/or vehicle) to enable dynamic transportation management system 810 to provide dynamic transportation matching and/or management services for the provider and one or more requestors. In some examples, provider apps 840(1)-(k) may coordinate communications and/or a payment between a requestor and a provider. According to some embodiments, provider apps 840(1)-(k) may provide a map service, a navigation service, a traffic notification service, and/or a geolocation service.

Additionally, as shown in FIG. 8, dynamic transportation matching system 810 may communicate with requestor devices 850(1)-(m). In some examples, requestor devices 850 may include a requestor app 860. Requestor app 860 may represent any application, program, and/or module that may provide one or more services related to requesting transportation matching services. For example, requestor app 860 may include a transportation matching application for requestors. In some examples, requestor app 860 may match the user of requestor app 860 (e.g., a user) with transportation providers through communication with dynamic transportation matching system 810. In addition, and as is described in greater detail below, requestor app 860 may provide dynamic transportation management system 810 with information about a requestor (including, e.g., the current location of the requestor) to enable dynamic transportation management system 810 to provide dynamic transportation matching services for the requestor and one or more providers. In some examples, requestor app 860 may coordinate communications and/or a payment between a requestor and a provider. According to some embodiments, requestor app 860 may provide a map service, a navigation service, a traffic notification service, and/or a geolocation service.

Embodiments of the instant disclosure may include or be implemented in conjunction with a dynamic transportation matching system. A transportation matching system may arrange transportation on an on-demand and/or ad-hoc basis by, e.g., matching one or more users with one or more transportation providers. For example, a transportation matching system may provide one or more transportation matching services for a networked transportation service, a ridesourcing service, a taxicab service, a car-booking service, an autonomous vehicle service, a personal mobility vehicle service, or some combination and/or derivative thereof. The transportation matching system may include and/or interface with any of a variety of subsystems that may implement, support, and/or improve a transportation matching service. For example, the transportation matching system may include a matching system (e.g., that matches requestors to ride opportunities and/or that arranges for requestors and/or providers to meet), a mapping system, a navigation system (e.g., to help a provider reach a requestor, to help a requestor reach a provider, and/or to help a provider reach a location), a reputation system (e.g., to rate and/or gauge the trustworthiness of a requestor and/or a provider), a payment system, and/or an autonomous or semi-autonomous driving system. The transportation matching system may be implemented on various platforms, including a requestor-owned mobile device, a computing system installed in a vehicle, a requestor-owned mobile device, a server computer system, or any other hardware platform capable of providing transportation matching services to one or more requestors and/or providers.

While various examples provided herein relate to transportation, embodiments of the instant disclosure may include or be implemented in conjunction with a dynamic matching system applied to one or more services instead of and/or in addition to transportation services. For example, embodiments described herein may be used to match service providers with service requestors for any service.

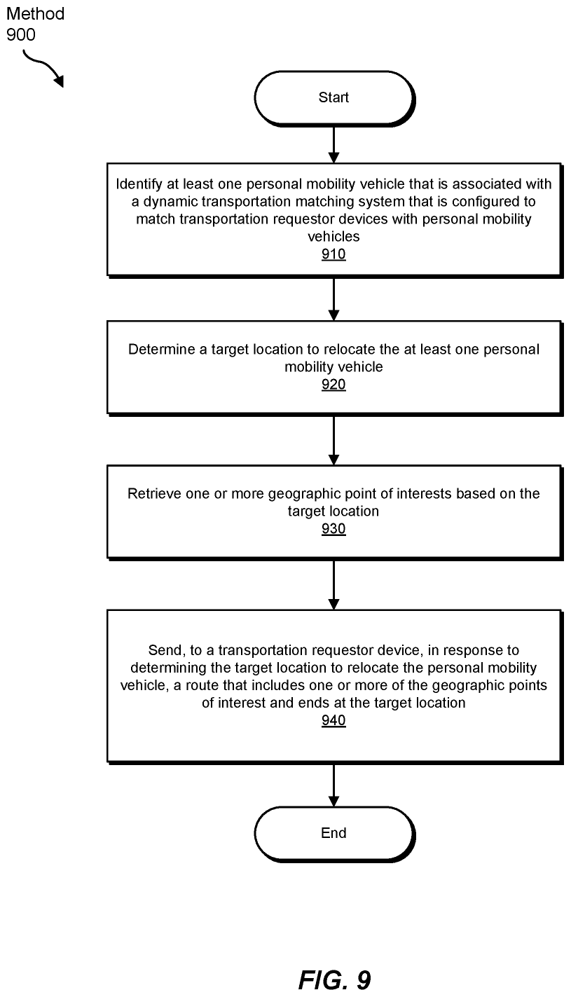

FIG. 9 illustrates an example computer-implemented method 900 for routing PMVs. As shown in FIG. 9, at step 910 one or more of the systems described herein may identify at least one PMV that is associated with a dynamic transportation matching system that is configured to match transportation requestor devices with PMVs. At step 920, one or more of the systems described herein may determine a target location to which to relocate the PMV. For example, the systems described herein may determine a utility to the dynamic transportation matching system of having the at least one PMV located at a target location. In some examples, the systems described herein determine that a utility to the dynamic transportation matching system of having the at least one PMV at a current location of the at least one PMV is less than the utility of having the at least one PMV located at the target location. In some examples, the systems described herein may determine the utility to the dynamic transportation matching system of having the at least one PMV located at the target location by determining a utility to the dynamic transportation matching system of having the at least one PMV located at the location at a predetermined time. In some examples, the systems described herein may determine the utility to the dynamic transportation matching system of having the at least one PMV located at the target location by predicting that at least one transportation requestor device will request transportation from the location at a later time. Additionally or alternatively, the systems described herein may determine the utility to the dynamic transportation matching system of having the at least one PMV located at the target location by determining that the at least one PMV is below a predetermined threshold for battery charge. In one embodiment, the systems described herein may determine the target location at least in part by predicting a match for the at least one personal mobility vehicle based on relocating the at least one personal mobility vehicle to the target location.

At step 930, one or more of the systems described herein may retrieve at least one geographic point of interest based on the target location. In some examples, the systems described herein may retrieve the set of geographic points of interest by determining that the route that includes the set of geographic points of interest ends at the target location before the predetermined time. In some examples, the systems described herein may retrieve the set of geographic points of interest based on the target location by determining a route that ends at the target location, includes the set of geographic points of interest, and does not exceed a predetermined travel distance. Additionally or alternatively, the systems described herein may retrieve the set of geographic points of interest based on the target location by selecting a category of user interest and retrieving geographic points of interest that match the category of user interest. In some examples, selecting the category of user interest may include identifying a transportation requestor device to which to send the option to traverse the route and determining the category of user interest relevant to the transportation requestor device based on at least one of an inferred preference and a selected preference of a user associated with the transportation requestor device. In some examples, the systems described herein may retrieve the set of geographic points of interest based on the target location by determining that the PMV will have a battery charge level that exceeds a predetermined threshold for battery charge level after arriving at the target location via traversing the set of geographic points of interest. In some examples, the systems described herein may retrieve the set of geographic points of interest based on the target location by determining a route with a minimum travel distance that traverses the set of geographic points of interest and ends at the target location.

At step 940, one or more of the systems described herein may send, to a transportation requestor device, in response to determining the utility to the dynamic transportation matching system of having the at least one PMV located at the target location, a route that includes the geographic points of interest and ends at the target location. In some embodiments, the systems described herein may send the option to traverse the route via the at least one PMV based at least in part on determining that the transportation requestor device is currently in proximity to the at least one PMV. In one embodiment, the systems described herein may send, to the transportation requestor device, the route based at least in part on determining a probability that the transportation requestor device will accept the route. In some examples, the systems described herein may determine the probability that the transportation requestor device will accept the route by determining, based on a location history of the transportation requestor device, that the transportation requestor device is currently within a geographic area that is not typical for the transportation requestor device.

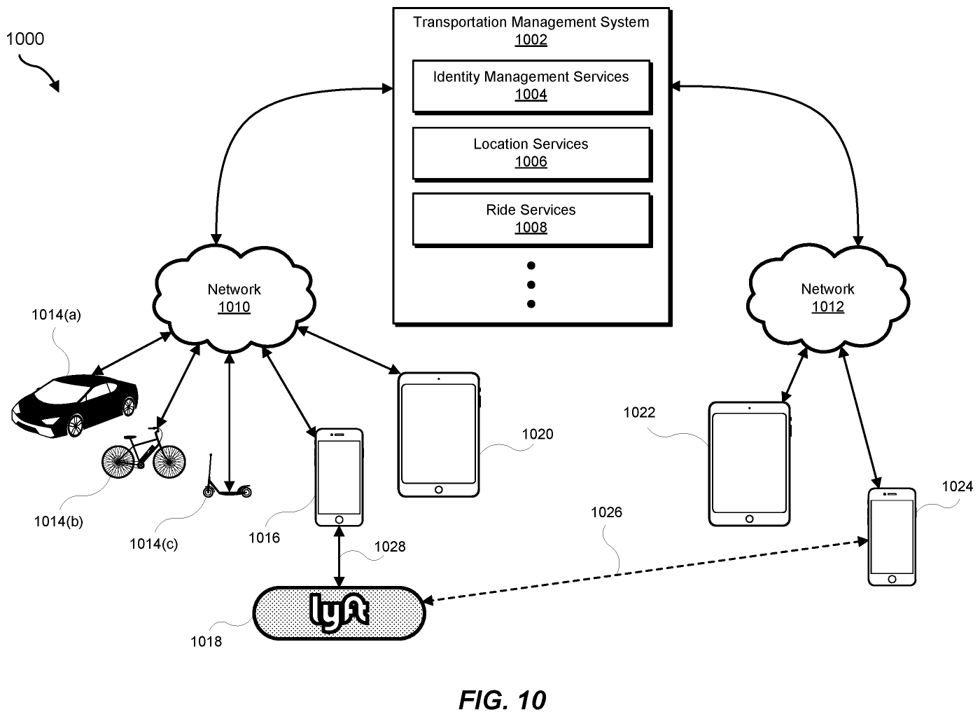

FIG. 10 shows a transportation management environment 1000, in accordance with various embodiments. As shown in FIG. 10, a transportation management system 1002 may run one or more services and/or software applications, including identity management services 1004, location services 1006, ride services 1008, and/or other services. Although FIG. 10 shows a certain number of services provided by transportation management system 1002, more or fewer services may be provided in various implementations. In addition, although FIG. 10 shows these services as being provided by transportation management system 1002, all or a portion of any of the services may be processed in a distributed fashion. For example, computations associated with a service task may be performed by a combination of transportation management system 1002 (including any number of servers, databases, etc.), one or more devices associated with a provider (e.g., devices integrated with managed vehicles 1014(a), 1014(b), and/or 1014(c); provider computing devices 1016 and tablets 1020; and transportation management vehicle devices 1018), and/or more or more devices associated with a ride requestor (e.g., the requestor's computing devices 1024 and tablets 1022). In some embodiments, transportation management system 1002 may include one or more general purpose computers, server computers, clustered computing systems, cloud-based computing systems, and/or any other computing systems or arrangements of computing systems. Transportation management system 1002 may be configured to run any or all of the services and/or software components described herein. In some embodiments, the transportation management system 1002 may include an appropriate operating system and/or various server applications, such as web servers capable of handling hypertext transport protocol (HTTP) requests, file transfer protocol (FTP) servers, database servers, etc.

In some embodiments, identity management services 1004 may be configured to perform authorization services for requestors and providers and/or manage their interactions and/or data with transportation management system 1002. This may include, e.g., authenticating the identity of providers and determining that they are authorized to provide services through transportation management system 1002. Similarly, requestors' identities may be authenticated to determine whether they are authorized to receive the requested services through transportation management system 1002. Identity management services 1004 may also manage and/or control access to provider and/or requestor data maintained by transportation management system 1002, such as driving and/or ride histories, vehicle data, personal data, preferences, usage patterns as a ride provider and/or as a ride requestor, profile pictures, linked third-party accounts (e.g., credentials for music and/or entertainment services, social-networking systems, calendar systems, task-management systems, etc.) and any other associated information. Transportation management system 1002 may also manage and/or control access to provider and/or requestor data stored with and/or obtained from third-party systems. For example, a requester or provider may grant transportation management system 1002 access to a third-party email, calendar, or task management system (e.g., via the user's credentials). As another example, a requestor or provider may grant, through a mobile device (e.g., 1016, 1020, 1022, or 1024), a transportation application associated with transportation management system 1002 access to data provided by other applications installed on the mobile device. In some examples, such data may be processed on the client and/or uploaded to transportation management system 1002 for processing.

In some embodiments, transportation management system 1002 may provide ride services 1008, which may include ride matching and/or management services to connect a requestor to a provider. For example, after identity management services module 1004 has authenticated the identity a ride requestor, ride services module 1008 may attempt to match the requestor with one or more ride providers. In some embodiments, ride services module 1008 may identify an appropriate provider using location data obtained from location services module 1006. Ride services module 1008 may use the location data to identify providers who are geographically close to the requestor (e.g., within a certain threshold distance or travel time) and/or who are otherwise a good match with the requestor. Ride services module 1008 may implement matching algorithms that score providers based on, e.g., preferences of providers and requestors; vehicle features, amenities, condition, and/or status; providers' preferred general travel direction and/or route, range of travel, and/or availability; requestors' origination and location locations, time constraints, and/or vehicle feature needs; and any other pertinent information for matching requestors with providers. In some embodiments, ride services module 1008 may use rule-based algorithms and/or machine-learning models for matching requestors and providers.

Transportation management system 1002 may communicatively connect to various devices through networks 1010 and/or 1012. Networks 1010 and 1012 may include any combination of interconnected networks configured to send and/or receive data communications using various communication protocols and transmission technologies. In some embodiments, networks 1010 and/or 1012 may include local area networks (LANs), wide-area networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 1010 and/or 1012 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 902.11 family of standards, Bluetooth, Bluetooth Low Energy, Near Field Communication (NFC), Z-Wave, and ZigBee). In various embodiments, networks 1010 and/or 1012 may include any combination of networks described herein or any other type of network capable of facilitating communication across networks 1010 and/or 1012.

In some embodiments, transportation management vehicle device 1018 may include a provider communication device configured to communicate with users, such as drivers, passengers, pedestrians, and/or other users. In some embodiments, transportation management vehicle device 1018 may communicate directly with transportation management system 1002 or through another provider computing device, such as provider computing device 1016. In some embodiments, a requestor computing device (e.g., device 1024) may communicate via a connection 1026 directly with transportation management vehicle device 1018 via a communication channel and/or connection, such as a peer-to-peer connection, Bluetooth connection, NFC connection, ad hoc wireless network, and/or any other communication channel or connection. Although FIG. 10 shows particular devices communicating with transportation management system 1002 over networks 1010 and 1012, in various embodiments, transportation management system 1002 may expose an interface, such as an application programming interface (API) or service provider interface (SPI) to enable various third parties which may serve as an intermediary between end users and transportation management system 1002.

In some embodiments, devices within a vehicle may be interconnected. For example, any combination of the following may be communicatively connected: vehicle 1014, provider computing device 1016, provider tablet 1020, transportation management vehicle device 1018, requestor computing device 1024, requestor tablet 1022, and any other device (e.g., smart watch, smart tags, etc.). For example, transportation management vehicle device 1018 may be communicatively connected to provider computing device 1016 and/or requestor computing device 1024. Transportation management vehicle device 1018 may establish communicative connections, such as connections 1026 and 1028, to those devices via any suitable communication technology, including, e.g., WLAN technologies implementing the IEEE 902.11 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 1002 using applications executing on their respective computing devices (e.g., 1016, 1018, 1020, and/or a computing device integrated within vehicle 1014), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 1014 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requestor, including an application associated with transportation management system 1002. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

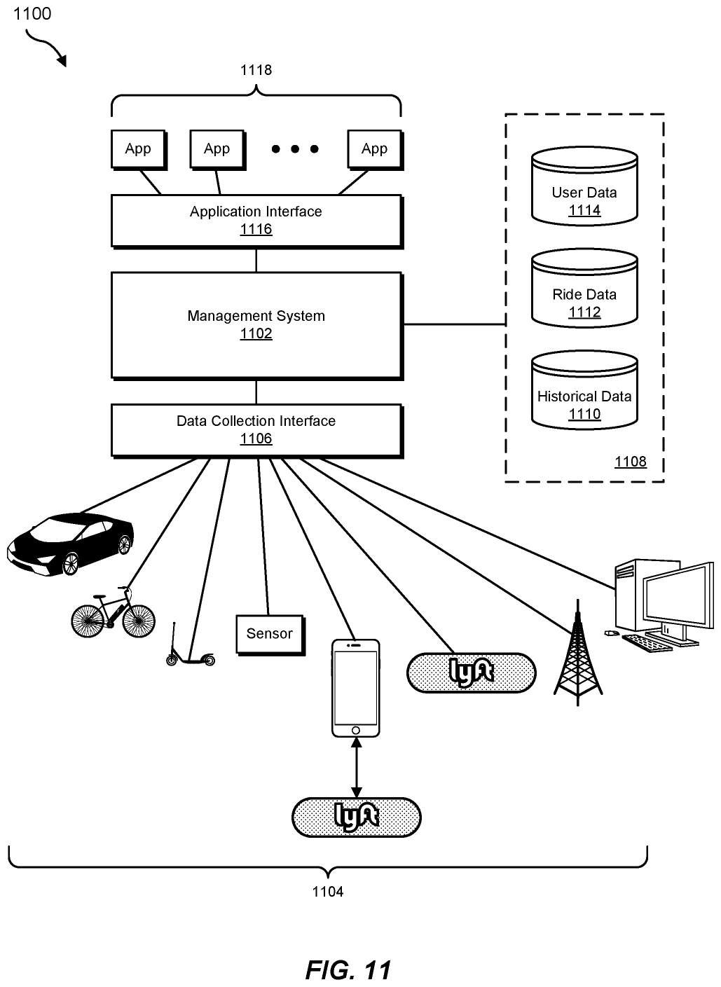

FIG. 11 shows a data collection and application management environment 1100, in accordance with various embodiments. As shown in FIG. 11, management system 1102 may be configured to collect data from various data collection devices 1104 through a data collection interface 1106. As discussed above, management system 1102 may include one or more computers and/or servers or any combination thereof. Data collection devices 1104 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1106 can include, e.g., an extensible device framework configured to support interfaces for each data collection device. In various embodiments, data collection interface 1106 may be extended to support new data collection devices as they are released and/or to update existing interfaces to support changes to existing data collection devices. In various embodiments, data collection devices may communicate with data collection interface 1106 over one or more networks. The networks may include any network or communication protocol as would be recognized by one of ordinary skill in the art, including those networks discussed above.

As shown in FIG. 11, data received from data collection devices 1104 can be stored in data store 1108. Data store 1108 may include one or more data stores, such as databases, object storage systems and services, cloud-based storage services, and other data stores. For example, various data stores may be implemented on a non-transitory storage medium accessible to management system 1102, such as historical data store 1110, ride data store 1112, and user data store 1114. Data stores 1108 can be local to management system 1102, or remote and accessible over a network, such as those networks discussed above or a storage-area network or other networked storage system. In various embodiments, historical data 1110 may include historical traffic data, weather data, request data, road condition data, or any other data for a given region or regions received from various data collection devices. Ride data 1112 may include route data, request data, timing data, and other ride related data, in aggregate and/or by requestor or provider. User data 1114 may include user account data, preferences, location history, and other user-specific data. Although certain data stores are shown by way of example, any data collected and/or stored according to the various embodiments described herein may be stored in data stores 1108.

As shown in FIG. 11, an application interface 1116 can be provided by management system 1102 to enable various apps 1118 to access data and/or services available through management system 1102. Apps 1118 may run on various user devices (including provider and requestor computing devices, such as those discussed above) and/or may include cloud-based or other distributed apps configured to run across various devices (e.g., computers, servers, or combinations thereof). Apps 1118 may include, e.g., aggregation and/or reporting apps which may utilize data 1108 to provide various services (e.g., third-party ride request and management apps). In various embodiments, application interface 1116 can include an API and/or SPI enabling third party development of apps 1118. In some embodiments, application interface 1116 may include a web interface, enabling web-based access to data 1108 and/or services provided by management system 1102. In various embodiments, apps 1118 may run on devices configured to communicate with application interface 1116 over one or more networks. The networks may include any network or communication protocol as would be recognized by one of ordinary skill in the art, including those networks discussed above, in accordance with an embodiment of the present disclosure.

While various embodiments of the present disclosure are described in terms of a networked transportation system in which the ride providers are human drivers operating their own vehicles, in other embodiments, the techniques described herein may also be used in environments in which ride requests are fulfilled using autonomous or semi-autonomous vehicles. For example, a transportation management system of a networked transportation service may facilitate the fulfillment of ride requests using both human drivers and autonomous vehicles. Additionally or alternatively, without limitation to transportation services, a matching system for any service may facilitate the fulfillment of requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
identifying at least one personal mobility vehicle that is associated with a dynamic transportation matching system that is configured to match transportation requestor devices with personal mobility vehicles;
determining a target location to relocate the at least one personal mobility vehicle;
retrieving one or more geographic points of interest based on the target location; and
sending, to a transportation requestor device, in response to determining the target location to relocate the personal mobility vehicle, a route that comprises the one or more geographic points of interest and ends at the target location.

2. The computer-implemented method of claim 1, further comprising predicting a match for the at least one personal mobility vehicle and one or more requestor devices, wherein the target location to relocate the at least one personal mobility vehicle is determined based on the predicted match.

3. The computer-implemented method of claim 1, wherein determining the target location to relocate the at least one personal mobility vehicle comprises determining that a utility to the dynamic transportation matching system of having the at least one personal mobility vehicle located at the target location exceeds a predetermined threshold for utility to the dynamic transportation matching system.

4. The computer-implemented method of claim 3, wherein determining the utility to the dynamic transportation matching system of having the at least one personal mobility vehicle located at the target location comprises determining a utility to the dynamic transportation matching system of having the at least one personal mobility vehicle located at the target location at a predetermined time.

5. The computer-implemented method of claim 3, further comprising:
predicting a second transportation requestor device to request transportation from the target location at a later time that is subsequent to a time at which the transportation requestor device can be relocated to the target location; and
determining the utility to the dynamic transportation matching system of having the at least one personal mobility vehicle located at the target location based at least in part on predicting that the second transportation requestor device will request transportation from the target location at the later time.

6. The computer-implemented method of claim 3, further comprising:
determining the at least one personal mobility vehicle comprises a battery charge below a threshold battery charge; and
determining the utility to the dynamic transportation matching system of having the at least one personal mobility vehicle located at the target location based at least in part on determining that the at least one personal mobility vehicle is below the threshold battery charge.

7. The computer-implemented method of claim 1:
further comprising selecting a predetermined travel distance;
wherein sending the route comprises determining a travel route that ends at the target location, comprises the one or more of the geographic points of interest, and does not exceed the predetermined travel distance.

8. The computer-implemented method of claim 1:
further comprising selecting a category of user interest associated with the transportation requestor device; and
wherein retrieving the one or more geographic points of interest comprises retrieving geographic points of interest that correlate with the category of user interest.

9. The computer-implemented method of claim 8, wherein selecting the category of user interest associated with the transportation requestor device comprises:
identifying a transportation requestor device to send the route; and
determining the category of user interest relevant to the transportation requestor device based on at least one of an inferred preference and a selected preference of a user associated with the transportation requestor device.

10. The computer-implemented method of claim 1, wherein retrieving the one or more geographic points of interest based on the target location comprises determining that the personal mobility vehicle will have a battery charge that exceeds a threshold battery charge after arriving at the target location via traversing the one or more geographic points of interest.

11. The computer-implemented method of claim 1, wherein retrieving the one or more geographic points of interest based on the target location comprises determining a route with a minimum travel distance that traverses the one or more geographic points of interest and ends at the target location.

12. The computer-implemented method of claim 1:
further comprising determining that the transportation requestor device is in proximity to the at least one personal mobility vehicle; and
wherein sending the route to the transportation requestor device is in response to determining that the transportation requestor device is in proximity to the at least one personal mobility vehicle.

13. The computer-implemented method of claim 12, wherein determining the transportation requestor device further comprises receiving a request from the transportation requestor device for travel that overlaps with the one or more geographic points of interest.

14. The computer-implemented method of claim 1, further comprising determining the transportation requestor device for the route based on a probability that the transportation requestor device will accept the route.

15. The computer-implemented method of claim 14, further comprising:
determining, based on a location history of the transportation requestor device, that the transportation requestor device is currently within a geographic area that is not typical for the transportation requestor device; and
determining the probability that the transportation requestor device will accept the route based at least in part on determining that the transportation requestor device is currently within the geographic area that is not typical for the transportation requestor device.

16. A system comprising:
an identification module, stored in memory, that identifies at least one personal mobility vehicle that is associated with a dynamic transportation matching system that is configured to match transportation requestor devices with personal mobility vehicles;
a determination module, stored in memory, that determines a target location to relocate the at least one personal mobility vehicle;
a retrieving module, stored in memory, that retrieves one or more geographic points of interest based on the target location;
a sending module, stored in memory, that sends, to a transportation requestor device, in response to determining the target location to relocate the personal mobility vehicle, a route that comprises the one or more geographic points of interest and ends at the target location; and
at least one physical processor that executes the identification module, the determination module, the retrieving module, and the sending module.

17. The system of claim 16, wherein the determination module determines the target location to relocate the at least one personal mobility vehicle by predicting a match for the at least one personal mobility vehicle based on relocating the at least one personal mobility vehicle to the target location.

18. The system of claim 16, wherein the determination module determines the target location to relocate the at least one personal mobility vehicle by determining that a utility to the dynamic transportation matching system of having the at least one personal mobility vehicle located at the target location exceeds a predetermined threshold for utility to the dynamic transportation matching system.

19. The system of claim 18, wherein the determination module determines the utility to the dynamic transportation matching system of having the at least one personal mobility vehicle located at the target location by determining a utility to the dynamic transportation matching system of having the at least one personal mobility vehicle located at the target location at a predetermined time.

20. A non-transitory computer-readable medium comprising:
computer-readable instructions that, when executed by at least one processor of a computing device, cause the computing device to:
identify at least one personal mobility vehicle that is associated with a dynamic transportation matching system that is configured to match transportation requestor devices with personal mobility vehicles;
determine a target location to relocate the at least one personal mobility vehicle;
retrieve one or more geographic points of interest based on the target location; and
send, to a transportation requestor device, in response to determining the target location to relocate the personal mobility vehicle, a route that comprises the one or more geographic points of interest and ends at the target location.
